(19) United States
(12) Patent Application Publication
(10) Pub. No.: US 2023/0223696 A1
(43) Pub. Date: Jul. 13, 2023

(54) PLANAR ANTENNA DEVICE

(71) Applicant: Socionext Inc., Kanagawa (JP)

(72) Inventor: Maki NAKAMURA, Yokohama (JP)

(21) Appl. No.: 18/180,554

(22) Filed: Mar. 8, 2023

Related U.S. Application Data
(63) Continuation of application No. PCT/JP2021/033900, filed on Sep. 15, 2021.
(60) Provisional application No. 63/085,041, filed on Sep. 29, 2020.

(51) Int. Cl. H01Q 9/04; H01Q 1/48

(52) U.S. Cl. CPC H01Q 9/0407; H01Q 1/48

(57) ABSTRACT

A planar antenna device includes: a dielectric; an antenna layer provided on one main surface of the dielectric; and a ground layer provided on an other main surface of the dielectric to oppose the antenna layer. The planar antenna device generates an electric field in a first direction along the other main surface by radiating radio waves with linear polarization from the antenna layer. The ground layer includes a grid-like ground electrode portion and a plurality of openings positioned in regions other than the ground electrode portion, each of the plurality of openings being quadrilateral in shape. Each of the plurality of openings includes two first opening sides parallel to the first direction and two second opening sides perpendicular to the first direction. A length of each of the first opening sides is longer than a length of each of the second opening sides.

### CROSS REFERENCE TO RELATED APPLICATIONS

This is a continuation application of PCT International Application No. PCT/JP2021/033900 filed on Sep. 15, 2021, designating the United States of America, which is based on and claims priority of U.S. Provisional Patent Application No. 63/085,041 filed on Sep. 29, 2020. The entire disclosures of the above-identified applications, including the specifications, drawings and claims are incorporated herein by reference in their entirety.

### FIELD

The present disclosure relates to a planar antenna device.

### BACKGROUND

Conventionally, an antenna device that is a kind of microstrip antenna is known. Patent Literature (PTL) 1 discloses an antenna device including a plate-shaped dielectric, an antenna electrode provided on one main surface of the dielectric, and a ground electrode provided on the other main surface of the dielectric.

### CITATION LIST

### Patent Literature

PTL 1: Japanese Unexamined Patent Application Publication No. 2020-184722

### SUMMARY

### Technical Problem

In the antenna device disclosed in PTL 1, an antenna electrode is formed on a portion of one main surface of the dielectric, and a ground electrode is formed on the entire other main surface of the dielectric (see (a) in FIG. 9 in PTL 1). For that reason, for example, when heat is applied to the antenna device, warpage may occur in the dielectric.

An object of the present disclosure is to provide a planar antenna device capable of suppressing warpage of a dielectric substrate.

### Solution to Problem

In order to achieve the above object, a planar antenna device according to an aspect of the present disclosure includes: a dielectric; an antenna layer provided on one main surface of the dielectric; and a ground layer provided on an other main surface of the dielectric to oppose the antenna layer, wherein the planar antenna device generates an electric field in a first direction along the other main surface by radiating radio waves with linear polarization from the antenna layer, the ground layer includes a ground electrode portion and a plurality of openings positioned in regions other than the ground electrode portion, the ground electrode portion being grid-like, each of the plurality of openings being quadrilateral in shape, each of the plurality of openings includes two first opening sides parallel to the first direction and two second opening sides perpendicular to the first direction, and a length of the first opening sides is longer than a length of the second opening sides.

In order to achieve the above object, a planar antenna device according to an aspect of the present disclosure includes: a dielectric; an antenna layer provided on one main surface of the dielectric; and a ground layer provided on an other main surface of the dielectric to oppose the antenna layer, wherein the planar antenna device generates an electric field in a first direction along the other main surface by radiating radio waves with linear polarization from the antenna layer, the ground layer includes a ground electrode portion and a plurality of openings positioned in regions other than the ground electrode portion, the ground electrode portion being grid-like, each of the plurality of openings being quadrilateral in shape, each of the plurality of openings includes two first opening sides parallel to the first direction and two second opening sides perpendicular to the first direction, a length of the first opening sides is at most 0.1 times longer than a wavelength of the radio waves, and a length of the second opening sides is at most 0.1 times longer than the wavelength of the radio waves.

In order to achieve the above object, a planar antenna device according to an aspect of the present disclosure includes: a dielectric; an antenna layer provided on one main surface of the dielectric; and a ground layer provided on an other main surface of the dielectric to oppose the antenna layer, wherein the ground layer includes a first ground electrode portion, a second ground electrode portion positioned in an area different from the first ground electrode portion, and a plurality of openings positioned in areas other than the first ground electrode portion and the second ground electrode portion, the first ground electrode portion being planar, the second ground electrode portion being grid-like, each of the plurality of openings being square in shape, and at least part of the first ground electrode portion overlaps the antenna layer when seen from a direction perpendicular to the other main surface.

### Advantageous Effects

According to the planar antenna device of the present disclosure, it is possible to suppress the occurrence of warpage in the dielectric substrate.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram showing a high-frequency device including a planar antenna device.

FIG. 2 is a diagram showing a planar antenna device of Comparative Example 1.

FIG. 3 is a diagram showing how warpage occurs in the planar antenna device of Comparative Example 1.

FIG. 4 is a diagram showing a ground electrode of a planar antenna device of Comparative Example 2.

FIG. 5 is a schematic diagram showing a planar antenna device.

FIG. 6 is a diagram showing a structure of a ground layer of a planar antenna device and a bandpass filter and the like configured by the ground layer.

FIG. 7 is a diagram showing a high-pass filter configured by a ground layer.

FIG. 8 is a diagram showing a low-pass filter configured by a ground layer.

FIG. 9 includes a top view and a front view of a planar antenna device according to Embodiment 1.

FIG. 10 is a bottom view of the planar antenna device according to Embodiment 1.

FIG. 11 is a diagram showing an example of feeding wiring for supplying electric power to the antenna layer of the planar antenna device.

FIG. 12 is a diagram showing another example of feed wiring for supplying electric power to the antenna layer of the planar antenna device.

FIG. 13 is a diagram showing the transmission characteristics of the ground layer of the planar antenna device according to Embodiment 1.

FIG. 14 is a schematic diagram showing a planar antenna device according to Embodiment 2.

FIG. 15 is a diagram showing an evaluation sample for evaluating the radiation characteristics of the planar antenna device according to Embodiment 2.

FIG. 16 is a diagram showing the radiation characteristics in the electric field plane of the planar antenna device according to Embodiment 2.

FIG. 17 is a diagram showing the radiation characteristics in the magnetic field plane of the planar antenna device according to Embodiment 2.

FIG. 18 is a diagram showing the cross polarization discrimination of the planar antenna device according to Embodiment 2.

FIG. 19 is a diagram showing another example of the cross polarization discrimination of the planar antenna device according to Embodiment 2.

FIG. 20 is a diagram showing the transmission characteristics of the ground layer of the planar antenna device according to Embodiment 2.

FIG. 21 is a diagram showing a planar antenna device according to Embodiment 3.

FIG. 22 is a diagram showing part of the bottom surface of a planar antenna device according to Variation 1 of Embodiment 3.

FIG. 23 is a diagram showing part of the bottom surface of a planar antenna device according to Variation 2 of Embodiment 3.

FIG. 24 is a diagram showing part of the bottom surface of a planar antenna device according to Variation 3 of Embodiment 3.

### DESCRIPTION OF EMBODIMENTS

### (Circumstances Leading to the Present Disclosure)

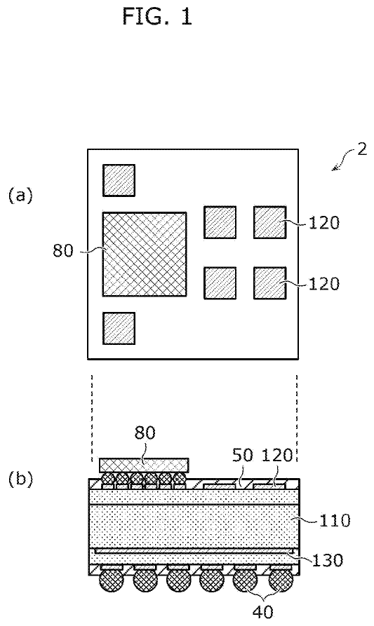

The circumstances leading to the present disclosure will be explained with reference to FIG. 1 to FIG. 4.

FIG. 1 is a diagram showing high-frequency device 2 including a planar antenna device. (a) in FIG. 1 is a plan view, and (b) in FIG. 1 is a sectional view seen from the front.

As shown in FIG. 1, high-frequency device 2 includes plate-shaped dielectric 110, antenna electrode 120 and LSI chip 80 provided on the top surface of dielectric 110, and a plurality of external terminals 40 provided on the bottom surface of dielectric 110. Resist 50 is provided on the upper surface of dielectric 110 so as to cover antenna electrode 120 and LSI chip 80. Ground electrode 130 is provided inside dielectric 110.

A planar antenna device is a type of microstrip antenna, and is used, for example, as an antenna for millimeter wave radar or an antenna for sensor devices. A planar antenna device includes dielectric 110, antenna electrode 120, and ground electrode 130 of high-frequency device 2. The following description focuses on the planar antenna device incorporated in high-frequency device 2.

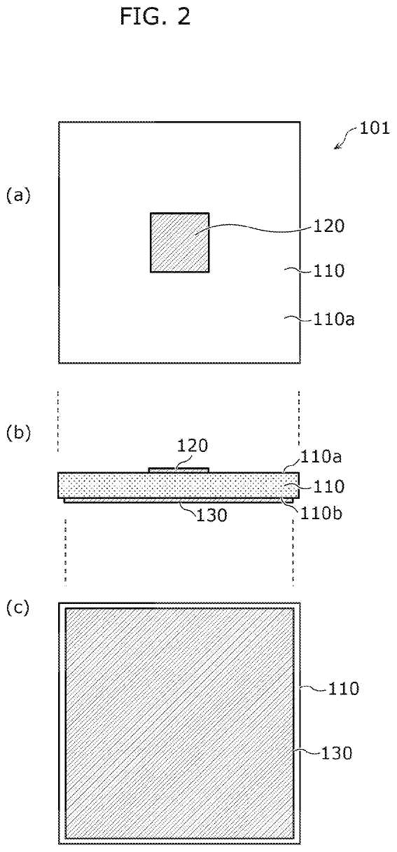

FIG. 2 is a diagram showing planar antenna device 101 of Comparative Example 1. In FIG. 2, (a) is a plan view, (b) is a sectional view seen from the front, and (c) is a bottom view.

Planar antenna device 101 of Comparative Example 1 includes antenna electrode 120 provided on one main surface 110a of dielectric 110 and ground electrode 130 provided on the other main surface 110b of dielectric 110. Antenna electrode 120 is a planar electrode and is also referred to as a patch antenna. Ground electrode 130 is a planar electrode and is set to a ground potential.

In planar antenna device 101 shown in FIG. 2, the area of ground electrode 130 is larger than that of antenna electrode 120. That is, the ratio of the electrode area to the area of each main surface is larger on the other main surface 110b than on one main surface 110a of dielectric 110. For example, the ratio of the electrode area on one main surface 110a is 10%, and the ratio of the electrode area on the other main surface 110b is 90%. It should be noted that the ratio of the electrode area to the area of each main surface may also be referred to as the residual copper ratio when the electrode material is copper.

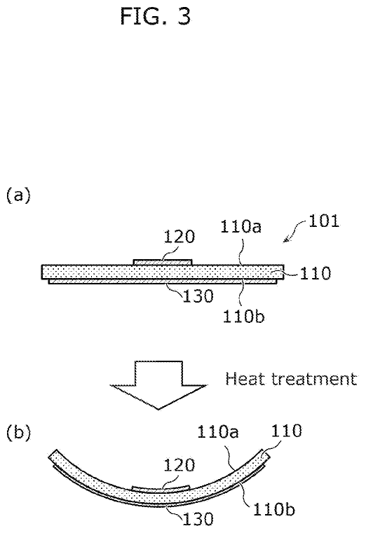

FIG. 3 is a diagram showing how warpage occurs in planar antenna device 101 of Comparative Example 1. (a) in FIG. 3 shows planar antenna device 101 before warpage occurs, and (b) in FIG. 3 shows planar antenna device 101 after warpage has occurred.

As in Comparative Example 1, if the difference between the ratio of the electrode area on one main surface 110a and the ratio of the electrode area on the other main surface 110b of dielectric 110 is significantly large, for example, when heat treatment is applied to planar antenna device 101, warpage may occur in dielectric 110 (see (b) in FIG. 3). When warpage occurs in dielectric 110, there is a problem that the antenna characteristics of planar antenna device 101 are changed. In addition, if warpage occurs in dielectric 110, it becomes difficult to mount the LSI chip on dielectric 110, and it becomes difficult to mount high-frequency device 2 incorporating planar antenna device 101 on the mother board.

As a countermeasure for these problems, it is conceivable to reduce the ratio of the electrode area of ground electrode 130 provided on the other main surface 110b to reduce warpage of dielectric 110.

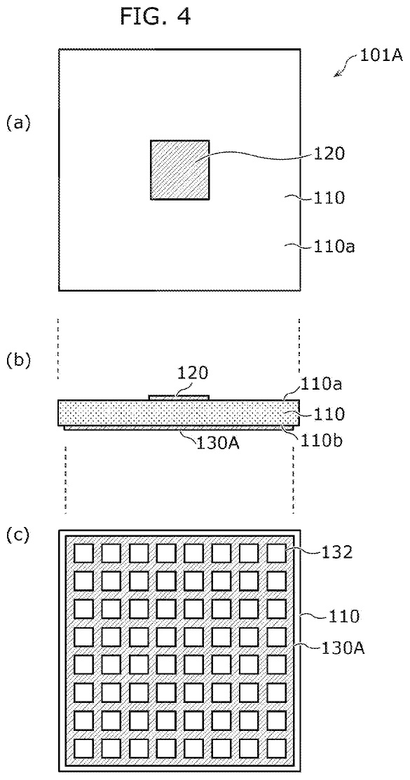

FIG. 4 is a diagram showing ground electrode 130A of planar antenna device 101A of Comparative Example 2. In FIG. 4, (a) is a plan view, (b) is a sectional view seen from the front, and (c) is a bottom view.

In planar antenna device 101A of Comparative Example 2, a plurality of openings 132 are provided in ground electrode 130A, and the ratio of the electrode area on the other main surface 110b side of dielectric 110 is smaller than in Comparative Example 1. Accordingly, it is possible to suppress the occurrence of warpage in dielectric 110.

On the other hand, however, if openings 132 are provided in ground electrode 130A, it is conceivable that the antenna characteristics of planar antenna device 101 will change. For example, if openings 132 are provided in ground electrode 130A, there is concern that ground electrode 130A cannot sufficiently serve as a ground for planar antenna device 101, which may change the antenna characteristics. In addition, it is conceivable that other electronic devices different from planar antenna device 101 may be adversely affected. For example, if openings 132 are provided in ground electrode 130A, electromagnetic waves radiated from antenna electrode 120 toward the other main surface 110b, that is, backward, pass through openings 132 and radiate toward the mother board. In planar antenna device 101A of Comparative Example 2, there is concern that electromagnetic waves radiated backward from antenna electrode 120 may cause malfunctions in other electronic devices mounted on the mother board. For that reason, simply reducing the ratio of the electrode area by simply providing openings 132 in ground electrode 130A as a countermeasure for suppressing the warpage of dielectric 110 may cause problems in other electronic devices.

Accordingly, the present disclosure provides an antenna device capable of suppressing the influence of electromagnetic waves radiated backward from the antenna electrode and suppressing the occurrence of warpage of the dielectric.

Hereinafter, embodiments of the present disclosure will be described in detail with reference to the drawings. It should be noted that each of the embodiments described below shows comprehensive or specific examples. The numerical values, shapes, materials, components, arrangement and connection forms of the components, and the like shown in the following embodiments are examples, and are not intended to limit the present disclosure. Among the components in the following embodiments, the components not described in the independent claims are described as arbitrary components. In addition, the sizes, or size ratios, of components shown in the drawings are not necessarily exact.

### Embodiment 1

### [Underlying Knowledge Forming Basis of the Present Disclosure]

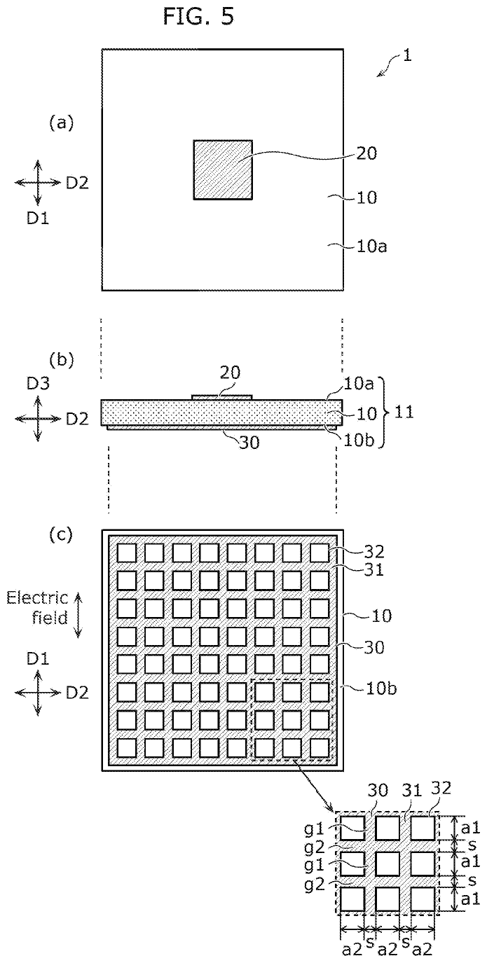

The underlying knowledge forming the basis of the present disclosure will be explained with reference to FIG. 5 to FIG. 7.

FIG. 5 is a schematic diagram showing planar antenna device 1. In FIG. 5, (a) is a plan view, (b) is a sectional view seen from the front, and (c) is a bottom view.

Planar antenna device 1 of the present disclosure includes antenna layer 20 provided on one main surface 10a of plate-shaped dielectric 10 and ground layer 30 provided on the other main surface 10b of dielectric 10. Dielectric 10 is formed of a dielectric material. Each of antenna layer 20 and ground layer 30 is formed of a metal material such as a copper electrode and the like. Planar antenna device 1 is realized by dielectric substrate 11 including dielectric 10, antenna layer 20, and ground layer 30.

Planar antenna device 1 generates an electric field in a predetermined direction by radiating radio waves with linear polarization from antenna layer 20. For example, when radio waves with linear polarization are radiated from antenna layer 20, as shown in (c) in FIG. 5, an electric field is generated in first direction D1 along the other main surface 10b, and a magnetic field is generated in second direction D2 along the other main surface 10b and perpendicular to first direction D1.

Ground layer 30 of planar antenna device 1 includes grid-like (or mesh-like) ground electrode portion 31 and a plurality of openings 32.

Ground electrode portion 31 includes a plurality of longitudinal grid electrodes g1 extending along first direction D1 and a plurality of lateral grid electrodes g2 extending along second direction D2. The plurality of longitudinal grid electrodes g1 are parallel to each other, the plurality of lateral grid electrodes g2 are parallel to each other, and longitudinal grid electrodes g1 and lateral grid electrodes g2 are orthogonal to each other.

Each of the plurality of openings 32 is quadrilateral in shape and is positioned in a region other than ground electrode portion 31. The plurality of openings 32 are provided in a matrix along first direction D1 and second direction D2. Each opening 32 has two first opening sides a1 parallel to first direction D1 and two second opening sides a2 parallel to second direction D2. It should be noted that in the drawings, the length of the first opening side is denoted as a1 like the reference numeral of first opening side a1, and the length of the second opening side is denoted as a2 like the reference numeral of second opening side a2.

In the present disclosure, the principle of frequency selective surfaces (FSS) is applied, an electrode structure having a size smaller than or equal to the wavelength of radio waves is continuously formed in ground layer 30, and a predetermined band pass filter is formed in ground layer 30. For example, if the passband width of a predetermined bandpass filter can be narrowed, the influence of electromagnetic waves radiated backward from antenna layer 20 can be suppressed. The structure of ground layer 30 will be described in detail below.

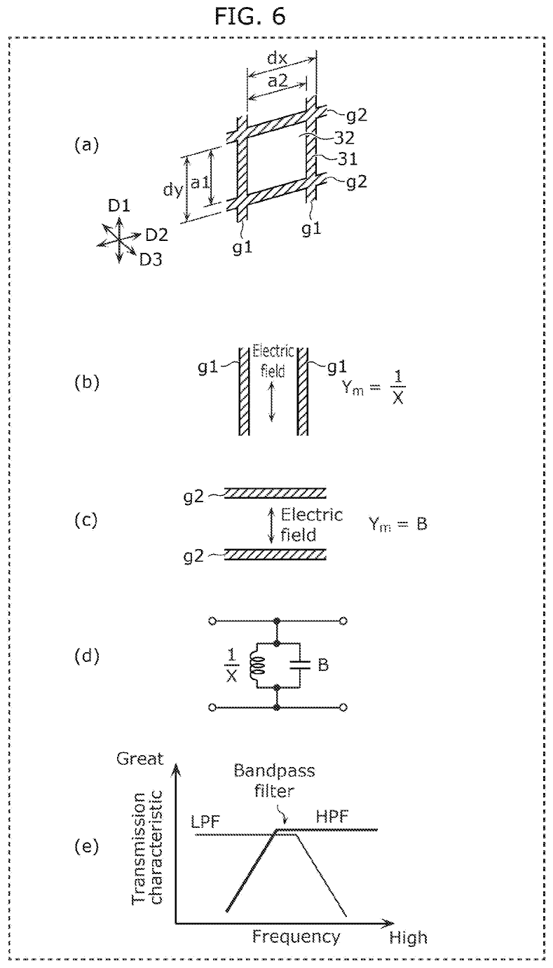

FIG. 6 is a diagram showing the structure of ground layer 30 of planar antenna device 1, the bandpass filter configured by ground layer 30, and the like.

Here, as shown in (a) in FIG. 6, the pitch of the plurality of longitudinal grid electrodes g1 arranged in order in second direction D2 (same as the center-to-center distance between two adjacent longitudinal grid electrodes g1) is dx, and the pitch of the plurality of lateral grid electrodes g2 arranged in order in first direction D1 (same as the center-to-center distance between two adjacent lateral grid electrodes g2) is dy. Opening 32 is a region surrounded by two longitudinal grid electrodes g1 and two lateral grid electrodes g2. Radio waves with linear polarization are radiated in third direction D3 perpendicular to both first direction D1 and second direction D2.

As shown in (b) in FIG. 6, when focusing on two longitudinal grid electrodes g1 parallel to the electric field direction, admittance Ym of ground layer 30 is formed by inductive component X based on longitudinal grid electrodes g1. In addition, as shown in (c) in FIG. 6, when focusing on two lateral grid electrodes g2 perpendicular to the electric field direction, admittance Ym of ground layer 30 is formed by capacitive component B based on lateral grid electrodes g2. Therefore, the equivalent circuit of ground layer 30 is represented by the LC resonant circuit shown in (d) in FIG. 6. (e) in FIG. 6 is a diagram showing a bandpass filter formed by ground layer 30 having the structure described above. The band-pass filter shown in the figure is configured by a high-pass filter (HPF) formed by inductive component X described above and a low-pass filter (LPF) formed by capacitive component B described above.

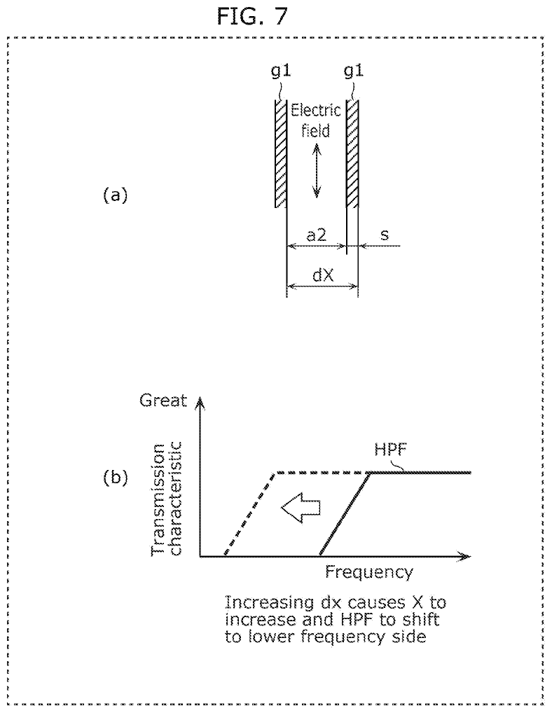

FIG. 7 is a diagram showing a high-pass filter configured by ground layer 30. Here, when pitch dx between two longitudinal grid electrodes g1 shown in (a) in FIG. 7 is increased, inductive component X described above becomes larger, and the high-pass filter formed by inductive component X moves to the low frequency side as shown in (b) in FIG. 7. As a result, ground layer 30 allows lower frequency electromagnetic waves to pass through. In other words, when the length of second opening side a2 of opening 32 is lengthened, ground layer 30 allows electromagnetic waves in a wider frequency band to pass through, and it becomes easy for the electromagnetic waves radiated backward from antenna layer 20 to pass through ground layer 30.

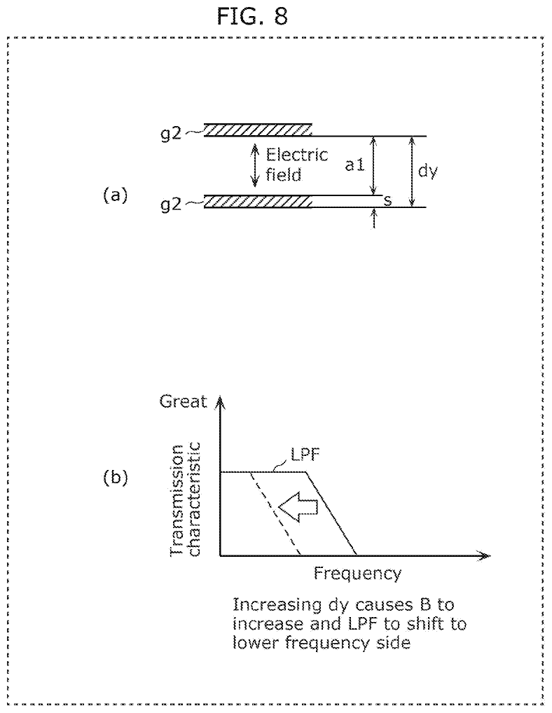

FIG. 8 is a diagram showing a low-pass filter configured by ground layer 30. Here, when pitch dy between two lateral grid electrodes g2 shown in (a) in FIG. 8 is increased, capacitive component B described above becomes larger, and the low-pass filter formed by capacitive component B moves to the low frequency side as shown in (b) in FIG. 8. As a result, ground layer 30 will not allow lower frequency electromagnetic waves to pass through. In other words, when the length of first opening side a1 of opening 32 is lengthened, ground layer 30 allows only electromagnetic waves in a narrow frequency band to pass through, and it becomes difficult for the electromagnetic waves radiated backward from antenna layer 20 to pass through ground layer 30.

In this way, it becomes easier for ground layer 30 to pass low-frequency electromagnetic waves as pitch dx of longitudinal grid electrodes g1 increases, and it becomes more difficult to pass high-frequency electromagnetic waves as pitch dy of lateral grid electrodes g2 increases. Since planar antenna device 1 of the present disclosure uses high frequencies in the millimeter wave band (30 GHz or higher), it is conceivable that increasing the length of second opening side a2 increases the influence of electromagnetic waves radiated backward from antenna layer 20. On the other hand, it is conceivable that even if the length of first opening side a1 is increased, the influence of the electromagnetic wave radiated backward from antenna layer 20 is small. Therefore, when reducing the ratio of the electrode area in ground layer 30, it is desirable to increase the length of first opening side a1 of opening 32 and not to increase the length of second opening side a2 more than necessary. Based on such knowledge, the planar antenna device according to Embodiment 1 will be described.

### [Configuration of Planar Antenna Device]

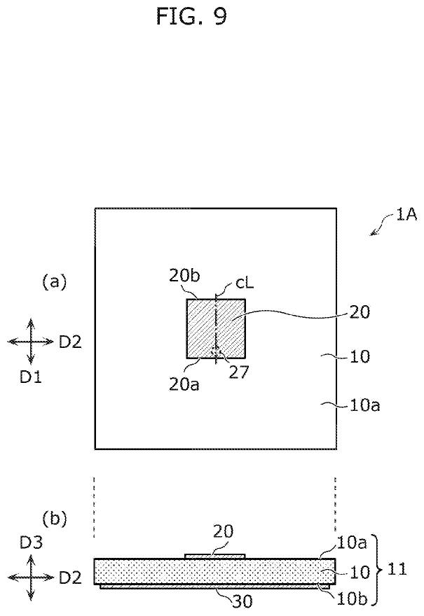

Planar antenna device 1A according to Embodiment 1 will be described with reference to FIG. 9 to FIG. 12.

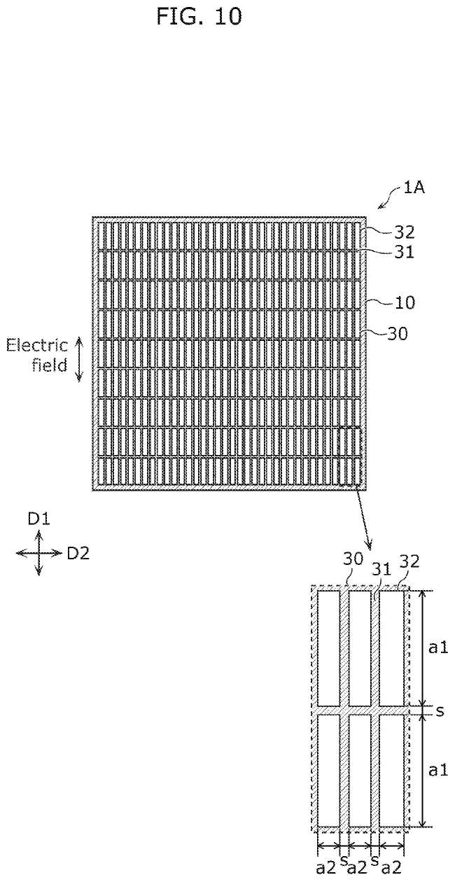

FIG. 9 includes a top view and a front cross-sectional view of planar antenna device 1A according to Embodiment 1. FIG. 10 is a bottom view of planar antenna device 1A.

As shown in FIG. 9 and FIG. 10, planar antenna device 1A includes dielectric 10, antenna layer 20, and ground layer 30. Planar antenna device 1A is realized by dielectric substrate 11 including dielectric 10, antenna layer 20, and ground layer 30.

Dielectric 10 of dielectric substrate 11 is formed of a dielectric material. Dielectric substrate 11 is, for example, a plate-like printed circuit board or the like. Dielectric substrate 11 may have a multilayer structure in which a plurality of dielectric layers are laminated.

Dielectric 10 has one principal surface 10a and the other principal surface 10b which is back on to the one principal surface 10a. In the present embodiment, one principal surface 10a is the top surface side, and the other principal surface 10b is the bottom surface side. The other main surface 10b side of dielectric 10 is the side facing the mother board when planar antenna device 1A is mounted on the mother board.

Antenna layer 20 is provided on one main surface 10a of dielectric 10. Antenna layer 20 is a planar electrode and is rectangular or square in shape. For example, antenna layer 20 has a thickness of 18 μm and is formed of a metal material containing copper.

Power is supplied to antenna layer 20 via feeding point 27 provided in antenna layer 20. Feeding point 27 is, for example, a region to which via conductor 16 for feeding is bonded.

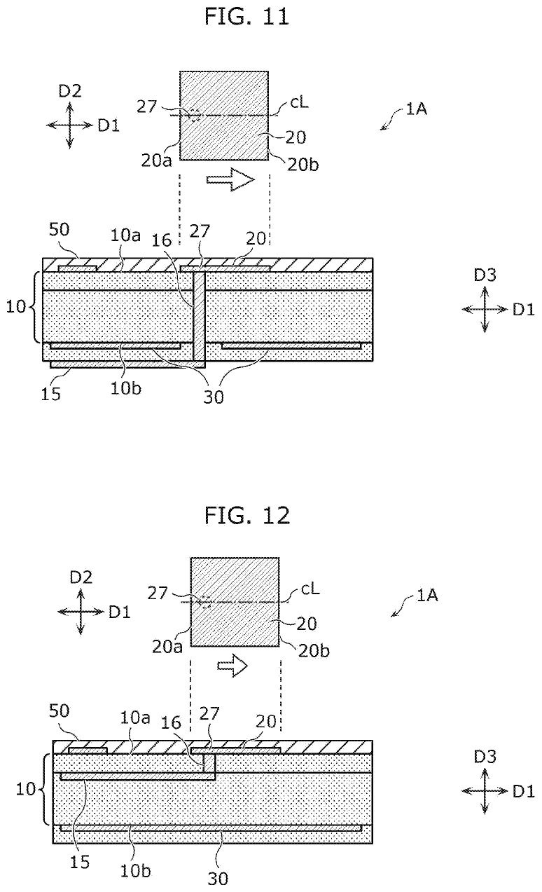

FIG. 11 is a diagram showing an example of feeding wiring for supplying power to antenna layer 20 of planar antenna device 1A. FIG. 12 is a diagram showing another example of feeding wiring for supplying power to antenna layer 20 of planar antenna device 1A. As shown in FIG. 11 and FIG. 12, feeding wiring for supplying power to antenna layer 20 is configured by via conductors 16 and wiring conductors 15 formed in dielectric 10.

Feeding point 27 is provided on center line cL of antenna layer 20. Center line cL is a line passing through the midpoints of two parallel sides of the four sides of antenna layer 20. Feeding point 27 is arranged near one side 20a of the two parallel sides. Feeding point 27 may be in contact with one side 20a, or may be positioned slightly closer to the other side 20b than one side 20a.

In the present embodiment, the direction in which center line cL of antenna layer 20 extends, in other words, the direction in which one side 20a and the other side 20b of the two sides face each other is the electric field direction. When a high-frequency signal is input to antenna layer 20 via feeding point 27, radio waves with linear polarization are radiated in a direction perpendicular to antenna layer 20 to generate an electric field in first direction D1 along center line cL and generate a magnetic field in second direction D2 orthogonal to the electric field direction. In this embodiment, ground layer 30 includes the structure shown below in order to suppress electromagnetic waves radiated backward from antenna layer 20 from passing through ground layer 30.

As shown in FIG. 9, ground layer 30 is provided on the other main surface 10b of dielectric 10 so as to oppose antenna layer 20. Ground layer 30 is connected to, for example, ground wiring and an external terminal of high-frequency device 2 and set to a ground potential. For example, ground layer 30 is 18 μm in thickness, which is the same thickness as antenna layer 20. Like antenna layer 20, ground layer 30 is also formed of a metal material containing copper.

Ground layer 30 includes grid-like ground electrode portion 31 and a plurality of quadrilateral openings 32 positioned in regions other than ground electrode portion 31. Ground layer 30 of the present embodiment includes a plurality of openings 32, and the ratio of the electrode area of ground layer 30 on the other main surface 10b side is smaller than that of Comparative Example 1, which is at least 20% and at most 75%.

Ground electrode portion 31 includes a plurality of longitudinal grid electrodes g1 extending along first direction D1 and a plurality of lateral grid electrodes g2 extending along second direction D2. The plurality of longitudinal grid electrodes g1 are parallel to each other, the plurality of lateral grid electrodes g2 are parallel to each other, and longitudinal grid electrodes g1 and lateral grid electrodes g2 are orthogonal to each other.

The plurality of openings 32 are provided in a matrix along the other main surface 10b. Each opening 32 includes two first opening sides a1 parallel to first direction D1 and two second opening sides a2 perpendicular to first direction D1. The respective lengths of first opening side a1 and second opening side a2 are sufficiently shorter than the wavelength of radio waves radiated from planar antenna device 1A. The wavelength of radio waves is the reciprocal of the oscillation frequency of radio waves radiated from planar antenna device 1A.

It should be noted that longitudinal grid electrode g1 of ground electrode portion 31 is provided between two openings 32 adjacent in second direction D2, and lateral grid electrode g2 is provided between two openings 32 adjacent in first direction D1. Width s of longitudinal grid electrode g1 and width s of lateral grid electrode g2 are the same, and each width s is shorter than or equal to the length of second opening side a2. For example, width s is equal to or shorter than the length of second opening side a2.

In addition, in the present embodiment, based on the knowledge mentioned above, the length of first opening side a1 is longer than the length of second opening side a2. In other words, the length of second opening side a2 is shorter than the length of first opening side a1. For example, the length of first opening side a1 is more than 1 time and less than 5 times the length of second opening side a2.

In addition, for example, the length of first opening side a1 is at most 0.1 times longer than the wavelength of the radio waves radiated from planar antenna device 1A, and the length of second opening side a2 is at most 0.05 times longer than of the wavelength of the radio wave radiated from planar antenna device 1A. When the oscillation frequency of planar antenna device 1A is 60 GHz and the dielectric constant of dielectric 10 is 4, the wavelength of the radio waves is about 5 mm, and the wavelength of the radio waves in dielectric 10 is about 2.5 mm due to the effect of shortening the wavelength, so that it is desirable that the length of first opening side a1 is 250 μm or less. When the oscillation frequency of planar antenna device 1A is 30 GHz and the dielectric constant of dielectric 10 is 4, the wavelength of the radio wave is about 10 mm, and the wavelength of the radio wave in dielectric 10 is about 5 mm due to the effect of shortening the wavelength, so that it is desirable that the length of first opening side a1 is 500 μm or less.

In this way, in planar antenna device 1A of the present embodiment, ground layer 30 includes a plurality of openings 32 other than the electrode portion, so that the ratio of the electrode area of ground layer 30 can be reduced. Accordingly, it is possible to suppress the occurrence of warpage in dielectric substrate 11. In addition, by making the length of first opening side a1 of opening 32 longer than the length of second opening side a2, the influence of electromagnetic waves radiated backward from antenna layer 20 can be suppressed.

### [Evaluation Results]

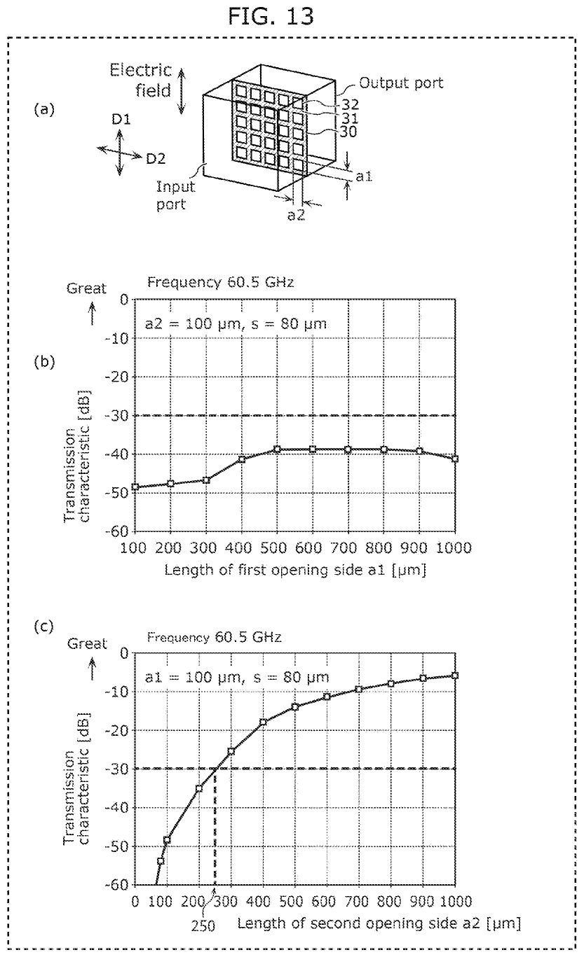

The transmission characteristics of ground layer 30 of planar antenna devices 1 and 1A will be described with reference to FIG. 13.

FIG. 13 is a diagram showing transmission characteristics of ground layer 30 of planar antenna devices 1 and 1A.

(a) in FIG. 13 shows a method of evaluating the transmission characteristics of ground layer 30. In this example, a high-frequency signal of 60.5 GHz was input with ground layer 30 arranged between the input port and the output port, and the insertion loss between the input port and the output port was measured.

(b) in FIG. 13 shows the transmission characteristics when the length of first opening side a1 of opening 32 of ground layer 30 is changed. The vertical axis of the figure represents the insertion loss between the input port and the output port, which shows that the larger the value, the easier it is for the electromagnetic waves to pass, and the smaller the value, the harder it is for the electromagnetic waves to pass. It should be noted that the length of second opening side a2 was fixed at 100 μm, and width s of each of longitudinal grid electrode g1 and lateral grid electrode g2 was fixed at 80 μm.

In the evaluation example shown in the figure, even if the length of first opening side a1 is changed, the transmission characteristics do not change so much. For example, if the evaluation criterion for transmission characteristics is −30 dB or less, the length of first opening side a1 satisfies this evaluation criterion in the range of at least 100 μm and at most 1000 μm. Accordingly, even if the length of first opening side a1 of opening 32 is increased, the result that the electromagnetic waves radiated backward from antenna layer 20 are still suppressed from passing through ground layer 30 is obtained. Therefore, when reducing the ratio of the electrode area of ground layer 30, it is desirable to increase the length of first opening side a1 of opening 32.

(c) in FIG. 13 shows the transmission characteristics when the length of second opening side a2 of opening 32 of ground layer 30 is changed. The longitudinal axis of the figure represents the insertion loss between the input port and the output port, which shows that the larger the value, the easier it is for the electromagnetic waves to pass, and the smaller the value, the harder it is for the electromagnetic waves to pass. It should be noted that the length of first opening side a1 was fixed at 100 μm, and width s of each of longitudinal grid electrode g1 and lateral grid electrode g2 was fixed at 80 μm.

In the evaluation example shown in the figure, the longer the length of second opening side a2, the greater the transmission characteristics. For example, if the evaluation criterion for transmission characteristics is −30 dB or less, this evaluation criterion is satisfied only when the length of second opening side a2 is 250 μm or less. That is, this evaluation criterion is satisfied only when the length of second opening side a2 is at most 0.05 times longer than the wavelength of the radio wave. Accordingly, if the length of second opening side a2 of opening 32 is longer than necessary, the result that the electromagnetic wave radiated backward from antenna layer 20 will pass through ground layer 30 is obtained. Therefore, when reducing the ratio of the electrode area of ground layer 30, it is not desirable to increase the length of second opening side a2 of opening 32 more than necessary.

### [Effects, Etc.]

Planar antenna device 1A according to the present embodiment includes dielectric 10, antenna layer 20 provided on one main surface 10a of dielectric 10, and ground layer 30 provided on the other main surface 10b of dielectric 10 so as to oppose antenna layer 20. Planar antenna device 1A generates an electric field in first direction D1 along the other main surface 10b by radiating radio waves with linear polarization from antenna layer 20. Ground layer 30 includes grid-like ground electrode portion 31 and a plurality of quadrilateral openings 32 positioned in regions other than ground electrode portion 31. Each of the plurality of openings 32 includes two first opening sides a1 parallel to first direction D1 and two second opening sides a2 perpendicular to first direction D1. The length of first opening side a1 is longer than the length of second opening side a2.

In this way, by ground layer 30 including the plurality of openings 32 other than the electrode portion, the ratio of the electrode area of ground layer 30 can be reduced. Accordingly, it is possible to suppress the occurrence of warpage in dielectric substrate 11. In addition, by making the length of first opening side a1 of opening 32 longer than the length of second opening side a2, the influence of electromagnetic waves radiated backward from antenna layer 20 can be suppressed.

In addition, the length of first opening side a1 may be at most 0.1 times longer than the wavelength of the radio waves.

In this way, by setting the length of first opening side a1 to at most 0.1 times longer than the wavelength of the radio wave, the influence of the electromagnetic wave radiated backward from antenna layer 20 can be suppressed.

In addition, the length of second opening side a2 may be at most 0.05 times longer than the wavelength of the radio wave.

In this way, by setting the length of second opening side a2 to at most 0.05 times longer than the wavelength of the radio waves, the influence of the electromagnetic waves radiated backward from antenna layer 20 can be further suppressed.

In addition, the plurality of openings 32 are provided in a matrix along the other main surface 10b, ground electrode portion 31 is positioned at least between two adjacent openings 32 along the other main surface 10b, and width s of ground electrode portion 31 positioned between two adjacent openings 32 may be shorter than or equal to the length of second opening side a2.

In this way, by setting width s of ground electrode portion 31 to be shorter than or equal to the length of second opening side a2, the region of the electrode portion can be reduced, and the ratio of the electrode area of ground layer 30 can be reduced. Accordingly, it is possible to suppress the occurrence of warpage in dielectric substrate 11.

### Embodiment 2

### [Configuration of Planar Antenna Device]

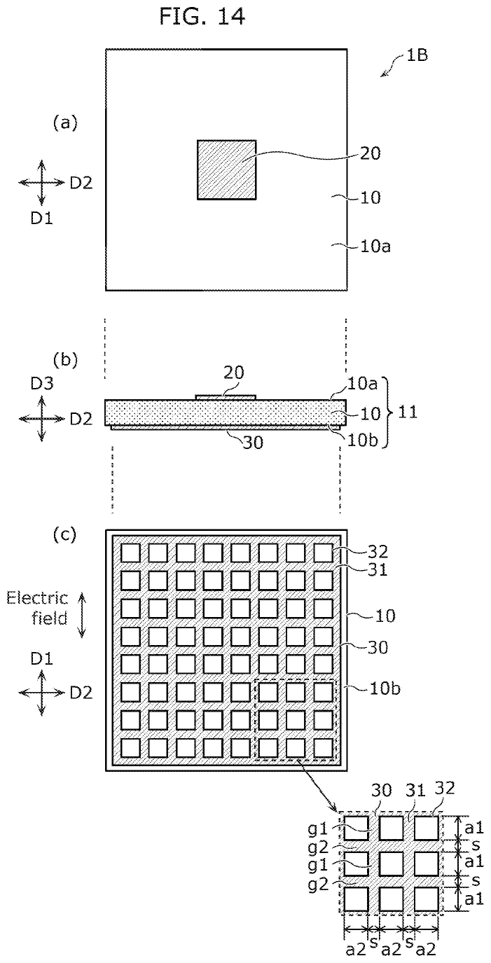

Planar antenna device 1B according to Embodiment 2 will be described with reference to FIG. 14.

FIG. 14 is a schematic diagram showing planar antenna device 1B according to Embodiment 2. In FIG. 14, (a) is a plan view, (b) is a sectional view seen from the front, and (c) is a bottom view.

As shown in FIG. 14, planar antenna device 1B includes dielectric 10, antenna layer 20, and ground layer 30. Dielectric 10 and antenna layer 20 have the same configurations as in Embodiment 1.

In the present embodiment, ground layer 30 has the structure shown below in order to suppress the disturbance of the radiation characteristics of planar antenna device 1B. In addition, in the present embodiment, ground layer 30 has the following structure in order to suppress deterioration of the cross polarization discrimination (XPD) of planar antenna device 1B. It should be noted that the cross polarization discrimination is a value obtained by dividing the main polarization by the cross polarization. In order to prevent the deterioration of the cross polarization discrimination, it is necessary to reduce the cross polarization that will be a noise.

As shown in FIG. 14, ground layer 30 is provided on the other main surface 10b of dielectric 10 so as to oppose antenna layer 20.

Ground layer 30 includes grid-like ground electrode portion 31 and a plurality of quadrilateral openings 32 positioned in regions other than ground electrode portion 31.

Ground electrode portion 31 includes a plurality of longitudinal grid electrodes g1 extending along first direction D1 and a plurality of lateral grid electrodes g2 extending along second direction D2. Longitudinal grid electrode g1 is provided between two openings 32 adjacent in second direction D2, and lateral grid electrode g2 is provided between two openings 32 adjacent in first direction D1. Each of width s of longitudinal grid electrode g1 and width s of lateral grid electrode g2 is shorter than or equal to the length of second opening side a2. For example, width s described above is a value between 0.2 and 0.5 times longer than the length of second opening side a2.

A plurality of openings 32 are provided in a matrix along the other main surface 10b. Each opening 32 includes two first opening sides a1 parallel to first direction D1 and two second opening sides a2 perpendicular to first direction D1. The lengths of first opening side a1 and second opening side a2 are sufficiently shorter than the wavelength of radio waves radiated from planar antenna device 1A. For example, the length of first opening side a1 is at most 0.1 times longer than the wavelength of radio waves. For example, the length of second opening side a2 is at most 0.1 times longer than the wavelength of radio waves, and more desirably at most 0.05 times longer than the wavelength of radio waves.

In this way, in planar antenna device 1B of Embodiment 2, ground layer 30 includes a plurality of openings 32 other than the electrode portion, so that the ratio of the electrode area of ground layer 30 can be reduced. Accordingly, it is possible to suppress the occurrence of warpage in dielectric substrate 11. In addition, the length of first opening side a1 is at most 0.1 times longer than the wavelength of the radio waves, and the length of second opening side a2 is at most 0.1 times longer than the wavelength of the radio waves. With this configuration, the influence of electromagnetic waves radiated backward from antenna layer 20 can be suppressed.

### [Evaluation Results]

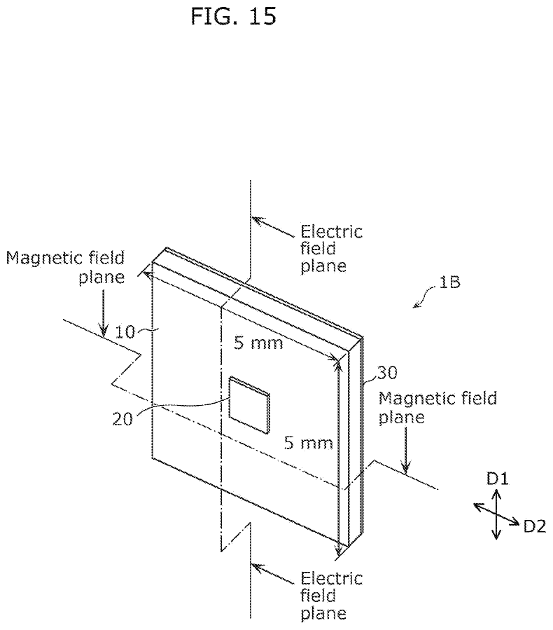

The radiation characteristics of planar antenna device 1B will be described with reference to FIG. 15 to FIG. 17.

FIG. 15 is a diagram showing an evaluation sample for evaluating radiation characteristics of planar antenna device 1B.

Dielectric 10 of planar antenna device 1B, which was an evaluation sample, was a substrate of 5 mm in length and width and 250 μm in thickness. The dielectric material included in dielectric 10 had a dielectric constant of 4 and a dielectric loss tangent of 0.01. Antenna layer 20 was a copper electrode measuring 1 mm in length and width and 18 μm in thickness. Ground layer 30 was a copper electrode measuring 5 mm in length and width and 18 μm in thickness. In addition, a resist covering antenna layer 20 and a resist covering ground layer 30 were provided on both main surfaces of dielectric 10 (not shown), and the thickness of each resist was set to 15 μm. It should be noted that the resist had a dielectric constant of 4 and a dielectric loss tangent of 0.018.

Then, a high-frequency signal was input to antenna layer 20 of this planar antenna device 1B, and radio waves with linear polarization were radiated from antenna layer 20. This caused an electric field in first direction D1 and a magnetic field in second direction D2 to be generated. The radiation characteristics of planar antenna device 1B were evaluated on the electric field plane and the magnetic field plane, respectively. It should be noted that the electric field plane is a plane along both first direction D1 and third direction D3, and the magnetic field plane is a plane along both second direction D2 and third direction D3. In addition, hereinafter, the direction toward the other main surface 10b when seen from antenna layer 20 is referred to as backward, and the direction opposite to the other main surface 10b is referred to as forward.

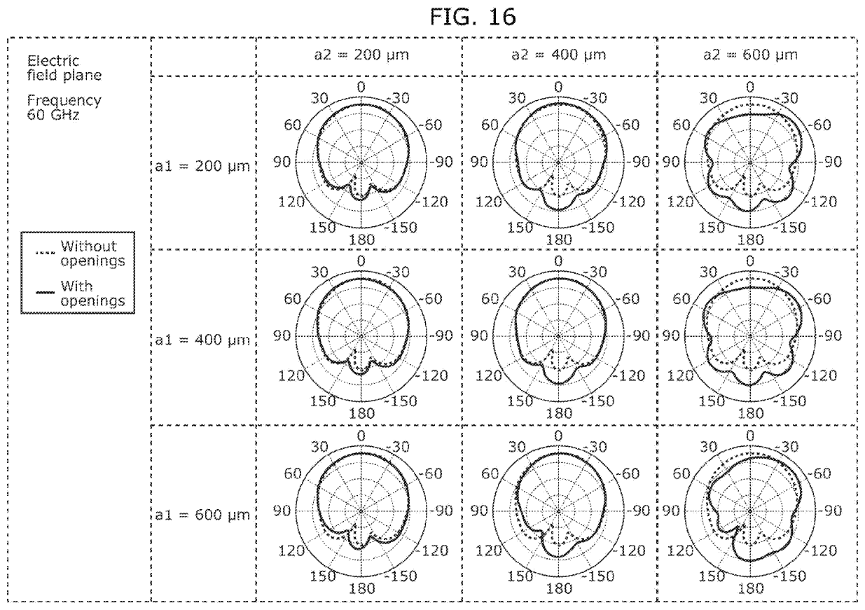

FIG. 16 is a diagram showing radiation characteristics in the electric field plane of planar antenna device 1B.

The dashed line in each figure in FIG. 16 indicates the radiation characteristics when ground layer 30 has no openings, and the solid line indicates the radiation characteristics when ground layer 30 is provided with openings 32. In the figure, the examples in which the length of first opening side a1 is changed to 200 μm (about 0.08 wavelength), 400 μm (about 0.16 wavelength), and 600 μm (about 0.24 wavelength), and the length of second opening side a2 is changed to 200 μm (approximately 0.08 wavelength), 400 μm (approximately 0.16 wavelength), and 600 μm (approximately 0.24 wavelength) are shown. FIG. 16 means that the closer the radiation characteristic of the solid line to the radiation characteristic of the dashed line, the less disturbing the radiation characteristics. It should be noted that considering that the oscillation frequency of planar antenna device 1B is 60 GHz, and considering the wavelength shortening in dielectric 10, 0.1 times the wavelength of the radio wave is about 250 μm, and 0.05 times the wavelength of the radio wave is about 125 μm. In the following, the difference in the length of the opening side with respect to the wavelength of radio waves will also be explained.

As shown in FIG. 16, when the length of second opening side a2 is 200 μm, even if the length of first opening side a1 is changed to 400 μm and 600 μm, the disturbance of radiation characteristics including backward radiation is small. Conversely, when the length of first opening side a1 is 200 μm, and the length of second opening side a2 is changed to 400 μm and 600 μm, the disturbance of the radiation characteristics including backward radiation increases.

FIG. 17 is a diagram showing radiation characteristics in the magnetic field plane of planar antenna device 1B.

The dashed line in each drawing in FIG. 17 indicates the radiation characteristics when ground layer 30 has no openings, and the solid line indicates the radiation characteristics when ground layer 30 is provided with openings 32. Solid lines show examples in which the length of first opening side a1 is changed to 200 μm, 400 μm and 600 μm, and the length of second opening side a2 is changed to 200 μm, 400 μm and 600 μm. FIG. 17 also means that the closer the radiation characteristic of the solid line to the radiation characteristic of the dashed line, the less disturbing the radiation characteristics.

As shown in FIG. 17, when the length of second opening side a2 is 200 μm, even if the length of first opening side a1 is changed to 400 μm and 600 μm, the disturbance of radiation characteristics including backward radiation is small. Conversely, when the length of first opening side a1 is 200 μm, and the length of second opening side a2 is changed to 400 μm and 600 μm, the disturbance of the radiation characteristics including backward radiation increases.

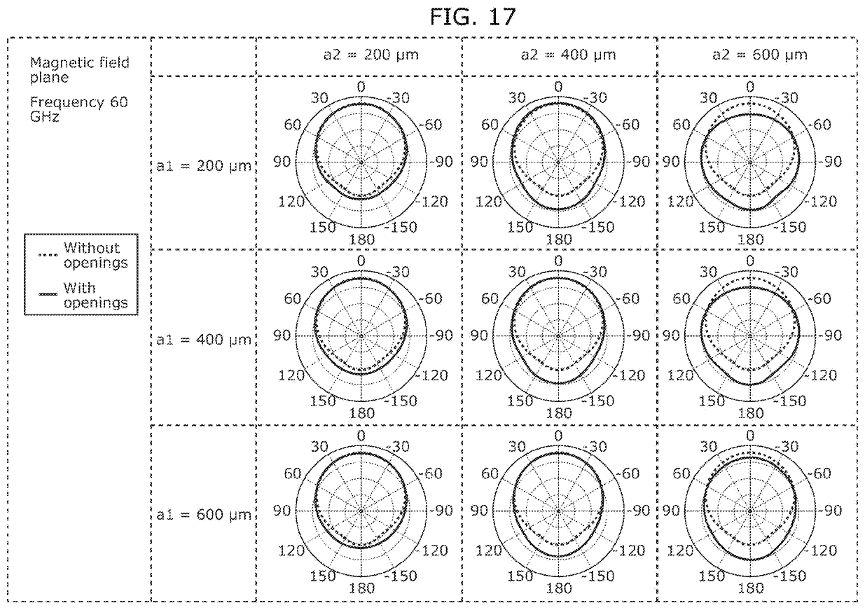

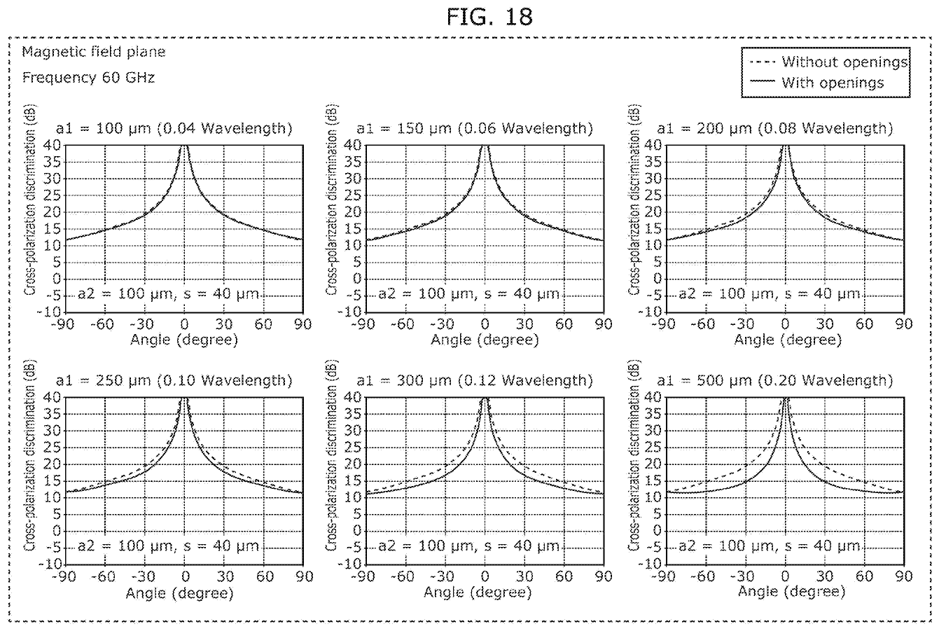

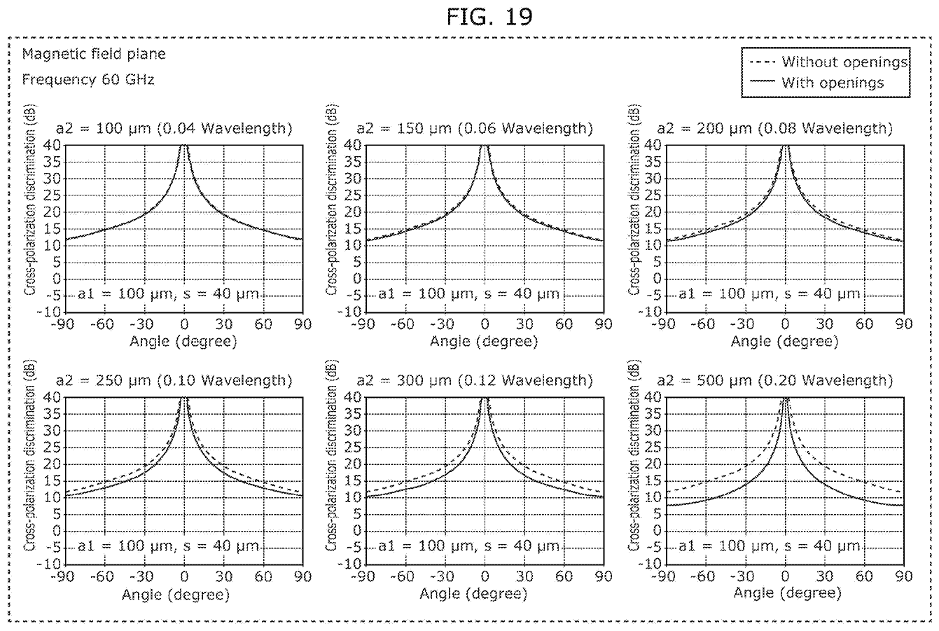

Next, the cross polarization discrimination of planar antenna device 1B will be described with reference to FIG. 18 and FIG. 19.

FIG. 18 is a diagram showing the cross polarization discrimination of planar antenna device 1B.

The vertical axis of each figure in FIG. 18 indicates the cross polarization discrimination (=main polarization/cross polarization) in the magnetic field plane, and the horizontal axis indicates the radiation angle. The figure means that the smaller the cross polarization discrimination, the more the antenna characteristics are degraded. It should be noted that the reason why the magnetic field plane was evaluated instead of the electric field plane is that the magnetic field plane showed a greater decrease in cross polarization discrimination than the electric field plane.

The broken line in each figure indicates the cross polarization discrimination when ground layer 30 has no opening, and the solid line indicates the cross polarization discrimination when ground layer 30 is provided with openings 32. The figure shows an example in which the length of first opening side a1 is changed in order to 100 μm, 150 μm, 200 μm, 250 μm, 300 μm, and 500 μm. It should be noted that the length of second opening side a2 was fixed at 100 μm, and width s of each of longitudinal grid electrode g1 and lateral grid electrode g2 was fixed at 40 μm.

In FIG. 18, for example, it is determined that if the cross polarization discrimination in the radiation angle range of ±60° is all greater than or equal to a predetermined threshold value, it is normal, and if it is smaller than the predetermined threshold value even at one point, the antenna characteristics have deteriorated. Although the predetermined threshold varies depending on the electronic device in which the planar antenna device is used, the predetermined threshold was set here to 13 dB in consideration of characteristic deterioration due to factors other than ground layer 30.

As shown in FIG. 18, the cross polarization discrimination in the radiation angle range of ±60° is greater than the predetermined threshold when the length of first opening side a1 is at most 0.10 times longer than the wavelength of the radio waves, and is smaller than the predetermined threshold when the length of first opening side a1 is at least 0.12 times longer than the wavelength of the radio waves. In this way, by setting the length of first opening side a1 to at most 0.10 times longer than the wavelength of the radio waves, it is possible to prevent the cross polarization discrimination from becoming small. In this way, deterioration of the antenna characteristics of planar antenna device 1B can be suppressed.

FIG. 19 is a diagram showing another example of the cross polarization discrimination of planar antenna device 1B.

The longitudinal axis of each figure in FIG. 19 indicates the cross polarization discrimination (=main polarization/cross polarization) in the magnetic field plane, and the horizontal axis indicates the radiation angle. The figure means that the smaller the cross polarization discrimination, the more the antenna characteristics are degraded.

The broken line in each figure represents the cross polarization discrimination when ground layer 30 has no opening, and the solid line represents the cross polarization discrimination when ground layer 30 is provided with openings 32. The figure shows an example in which the length of second opening side a2 is changed in order to 100 μm, 150 μm, 200 μm, 250 μm, 300 μm, and 500 μm. The length of first opening side a1 was fixed at 100 μm, and width s of each of longitudinal grid electrode g1 and lateral grid electrode g2 was fixed at 40 μm.

In FIG. 19 as well, it is determined that if the cross polarization discrimination in the radiation angle range of ±60° is smaller than a predetermined threshold even at one point, the antenna characteristics have deteriorated. The predetermined threshold was set to 13 dB.

As shown in FIG. 19, the cross polarization discrimination in the radiation angle range of ±60° is greater than a predetermined threshold when the length of second opening side a2 is at most 0.10 times longer than the wavelength of the radio waves, and is smaller than the predetermined threshold when the length of second opening side a2 is at least 0.12 times longer than the wavelength of the radio wave. In this way, by setting the length of second opening side a2 to be at most 0.10 times longer than the wavelength of the radio wave, it is possible to suppress the reduction in the cross polarization discrimination. Accordingly, deterioration of the antenna characteristics of planar antenna device 1B can be suppressed.

Next, the transmission characteristics of ground layer 30 when the ratio of the electrode area of ground layer 30 is the same and the size and number of openings 32 are changed will be described.

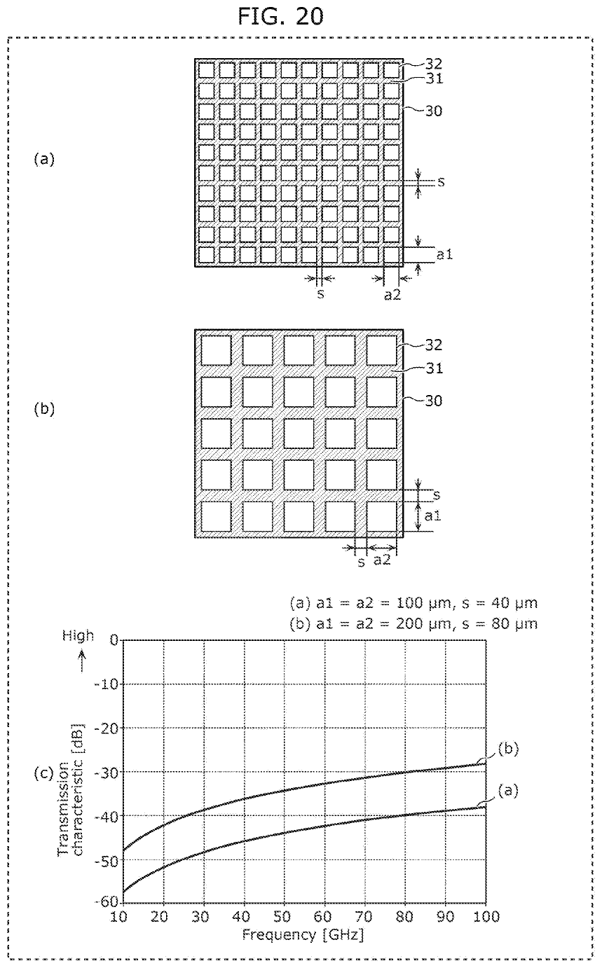

FIG. 20 is a diagram showing the structure and transmission characteristics of the ground layer of planar antenna device 1B.

(a) and (b) in FIG. 20 shows ground layer 30 having different sizes and numbers of openings 32. (a) in FIG. 20 shows an example in which the length of each of first opening side a1 and second opening side a2 is 100 μm, and width s of each of longitudinal grid electrode g1 and lateral grid electrode g2 is 40 μm. (b) in FIG. 20 shows an example in which the length of each of first opening side a1 and second opening side a2 is 200 μm, and width s of each of longitudinal grid electrode g1 and lateral grid electrode g2 is 80 μm. The ratios of the electrode area of ground layer 30 in (a) and (b) in FIG. 20 are both 49%.

The evaluation method of the transmission characteristic is almost the same as that of (a) in FIG. 13, and high-frequency signals are input with the respective ground layers 30 in (a) and (b) in FIG. 20 placed between the input port and the output port to measure the insertion loss between the input port and the output port.

(c) in FIG. 20 shows the transmission characteristics when the frequency is changed. The vertical axis represents the insertion loss between the input port and the output port, and the larger the value, the easier it is for electromagnetic waves to pass, and the smaller the value, the harder it is for electromagnetic waves to pass.

As shown in the figure, the transmission characteristic of ground layer 30 increases as the frequency of the input signal increases. For example, when the evaluation criterion for the transmission characteristics is −30 dB or less, ground layer 30 shown in (a) in FIG. 20 satisfies the evaluation criterion even in the high frequency, but ground layer 30 shown in (b) in FIG. 20 has the transmission characteristic larger than the evaluation criterion when the frequency is 80 GHz. Therefore, when the ratio of the electrode area of ground layer 30 is the same, the smaller size of opening 32 is more desirable, and shorter width s of longitudinal grid electrode g1 and width s of lateral grid electrode g2 are more desirable. It is desirable that the size of opening 32 and width s are appropriately set according to respective manufacturing limits.

### [Effects, etc.]

Planar antenna device 1B according to the present embodiment includes dielectric 10, antenna layer 20 provided on one main surface 10a of dielectric 10, and ground layer 30 provided on the other main surface 10b of dielectric 10 so as to oppose antenna layer 20. Planar antenna device 1B generates an electric field in first direction D1 along the other main surface 10b by radiating radio waves with linear polarization from antenna layer 20. Ground layer 30 includes grid-like ground electrode portion 31 and a plurality of quadrilateral openings 32 positioned in regions other than ground electrode portion 31. Each of the plurality of openings 32 includes two first opening sides a1 parallel to first direction D1 and two second opening sides a2 perpendicular to first direction D1. The length of first opening side a1 is at most 0.1 times longer than the wavelength of the radio waves, and the length of second opening side a2 is at most 0.1 times longer than the wavelength of the radio waves.

In this way, by ground layer 30 including the plurality of openings 32 other than the electrode portion, the ratio of the electrode area of ground layer 30 can be reduced. Accordingly, it is possible to suppress the occurrence of warpage in dielectric substrate 11. In addition, by setting the length of first opening side a1 to at most 0.1 times longer than the wavelength of radio waves and the length of second opening side a2 to at most 0.1 times longer than the wavelength of radio waves, the disturbance in radiation characteristics of planar antenna device 1B can be reduced (see FIG. 18 and FIG. 19). Accordingly, the influence of electromagnetic waves radiated backward from antenna layer 20 can be suppressed.

In addition, the length of second opening side a2 may be at most 0.05 times longer than the wavelength of the radio waves.

In this way, by setting the length of second opening side a2 to at most 0.05 times longer than the wavelength of the radio wave, it is possible to further reduce the disturbance of the radiation characteristics of planar antenna device 1B (see (c) in FIG. 13). Accordingly, the influence of electromagnetic waves radiated backward from antenna layer 20 can be suppressed.

In addition, the plurality of openings 32 are provided in a matrix along the other main surface 10b, and ground electrode portion 31 is positioned at least between two adjacent openings 32 along the other main surface 10b, and width s of ground electrode portion 31 positioned between two adjacent openings 32 may be shorter than or equal to the length of second opening side a2.

In this way, by setting width s of ground electrode portion 31 to be shorter than or equal to the length of second opening side a2, the region of the electrode portion can be reduced, and the ratio of the electrode area of ground layer 30 can be reduced. Accordingly, it is possible to suppress the occurrence of warpage in dielectric substrate 11.

### Embodiment 3

### [Configuration of Planar Antenna Device]

A configuration of planar antenna device 1C according to Embodiment 3 will be described. In Embodiment 3, an example in which ground electrode portion 31 is configured by planar first ground electrode portion 31a and grid-like second ground electrode portion 31b will be described.

FIG. 21 is a diagram showing planar antenna device 1C according to Embodiment 3. (a) in FIG. 21 is a top view, and (b) is a bottom view.

As shown in FIG. 21, planar antenna device 1C includes dielectric 10, antenna layer 20, and ground layer 30. Planar antenna device 1C generates an electric field in first direction D1 along the other main surface 10b by radiating radio waves with linear polarization from antenna layer 20. Dielectric 10 and antenna layer 20 have the same configurations as in Embodiment 1.

As shown in the bottom view of (b) in FIG. 21, ground layer 30 is provided on the other main surface 10b of dielectric 10 so as to oppose antenna layer 20.

Ground layer 30 includes planar first ground electrode portion 31a, grid-like second ground electrode portion 31b positioned in a region different from first ground electrode portion 31a, and a plurality of quadrilateral openings 32 positioned in regions other than first ground electrode portion 31a and second ground electrode portion 31b and the second ground electrode portion 31b. At least part of first ground electrode portion 31a overlaps antenna layer 20 when seen from a direction perpendicular to the other main surface 10b.

In planar antenna device 1C of Embodiment 3, ground electrode portion 31 is configured by planar first ground electrode portion 31a and grid-like second ground electrode portion 31b, and at least part of first ground electrode portion 31a overlaps antenna layer 20 when seen from a direction perpendicular to the other main surface 10b. By having this structure, planar antenna device 1C can suppress the influence of electromagnetic waves radiated backward from antenna layer 20 and suppress the occurrence of warpage in dielectric substrate 11.

### Variation 1 of Embodiment 3

A configuration of planar antenna device 1C according to Variation 1 of Embodiment 3 will be described. In Variation 1, an example in which ground electrode portion 31A is configured by planar first ground electrode portion 31a and grid-like second ground electrode portion 31b will be described.

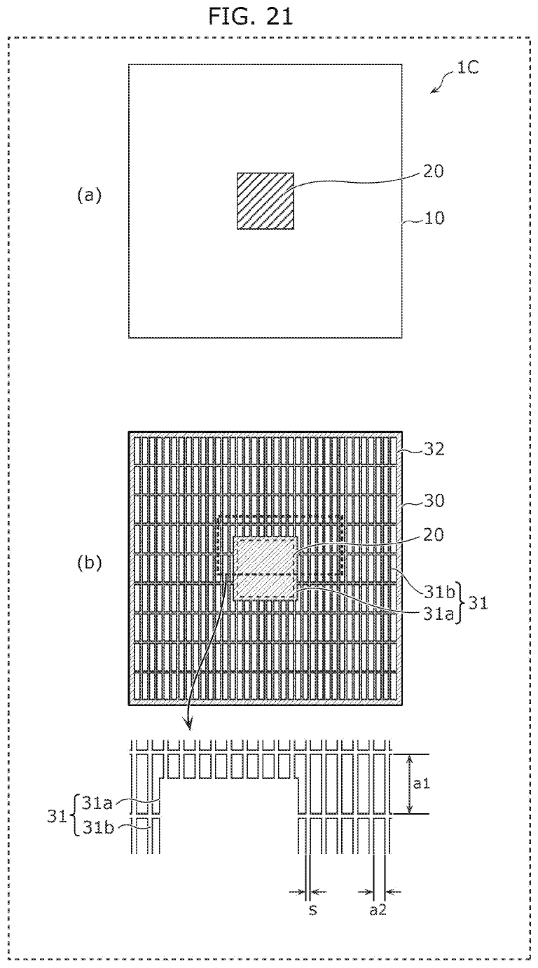

FIG. 22 is a diagram showing part of the bottom surface of planar antenna device 1C according to Variation 1.

As shown in FIG. 22, ground layer 30 includes planar first ground electrode portion 31a, grid-like second ground electrode portion 31b positioned in a region different from first ground electrode portion 31a, and a plurality of quadrilateral openings 32 positioned in regions other than the electrodes of first ground electrode portion 31a and the second ground electrode portion 31b. In addition, planar first ground electrode portion 31a has a shape larger than that of antenna layer 20 when seen from the direction perpendicular to the other main surface 10b. By having this structure, planar antenna device 1C of Variation 1 can suppress the influence of electromagnetic waves radiated backward from antenna layer 20 and suppress the occurrence of warpage in dielectric substrate 11.

### Variation 2 of Embodiment 3

A configuration of planar antenna device 1C according to Variation 2 of Embodiment 3 will be described. In Variation 2, an example in which ground electrode portion 31B is configured by planar first ground electrode portion 31a and grid-like second ground electrode portion 31b will be described.

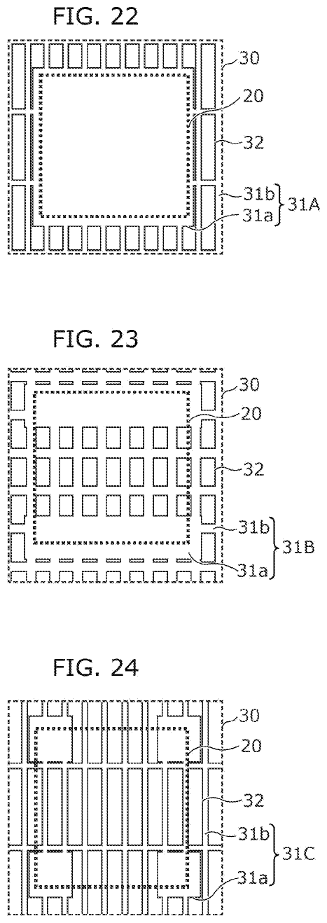

FIG. 23 is a diagram showing part of the bottom surface of planar antenna device 1C according to Variation 2.

As shown in FIG. 23, ground layer 30 includes planar first ground electrode portion 31a, grid-like second ground electrode portion 31b positioned in a region different from first ground electrode portion 31a, and a plurality of rectangular openings 32 positioned in regions other than the electrodes of first ground electrode portion 31a and the second ground electrode portion 31b. In addition, antenna layer 20 is rectangular in shape, and planar first ground electrode portion 31a overlaps the corners of antenna layer 20 when seen from the direction perpendicular to the other main surface 10b. By having this structure, planar antenna device 1C of Variation 2 can suppress the influence of electromagnetic waves radiated backward from antenna layer 20 and suppress the occurrence of warpage in dielectric substrate 11.

### Variation 3 of Embodiment 3

A configuration of planar antenna device 1C according to Variation 3 of Embodiment 3 will be described. In Variation 3, an example in which ground electrode portion 31C is configured by planar first ground electrode portion 31a and grid-like second ground electrode portion 31b will be described.

FIG. 24 is a diagram showing part of the bottom surface of planar antenna device 1C according to Variation 3.

As shown in FIG. 24, ground layer 30 includes a plurality of planar first ground electrode portions 31a, grid-like second ground electrode portion 31b positioned in a region different from first ground electrode portion 31a, and a plurality of quadrilateral openings 32 positioned in regions other than the electrodes of first ground electrode portion 31a and the second ground electrode portion 31b. In addition, antenna layer 20 is quadrilateral in shape, and planar first ground electrode portion 31a overlaps the corners of antenna layer 20 when seen from the direction perpendicular to the other main surface 10b. By having this structure, planar antenna device 1C of Variation 3 can suppress the influence of electromagnetic waves radiated backward from antenna layer 20 and suppress the occurrence of warpage in dielectric substrate 11.

### [Effects, etc.]

Planar antenna device 1C according to the present embodiment includes dielectric 10, antenna layer 20 provided on one main surface 10a of dielectric 10, and ground layer 30 provided on the other main surface 10b of dielectric 10 so as to oppose antenna layer 20. Ground layer 30 includes planar first ground electrode portion 31a, grid-like second ground electrode portion 31b positioned in a region different from first ground electrode portion 31a, and a plurality of quadrilateral openings 32 positioned in areas other than first ground electrode portion 31a and second ground electrode portion 31b. At least part of first ground electrode portion 31a overlaps antenna layer 20 when seen from a direction perpendicular to the other main surface 10b.

In this way, ground layer 30 includes a plurality of openings 32 other than the electrode portion, so that the ratio of the electrode area of ground layer 30 can be reduced. Accordingly, it is possible to suppress the occurrence of warpage in dielectric substrate 11. In addition, at least part of first ground electrode portion 31a overlaps antenna layer 20 when seen from the direction perpendicular to the other main surface 10b, so that the influence of the electromagnetic waves radiated backward from antenna layer 20 can be suppressed.

In addition, first ground electrode portion 31a may be larger than antenna layer 20 when seen from the direction perpendicular to the other main surface 10b.

According to this configuration, the influence of electromagnetic waves radiated backward from antenna layer 20 can be further suppressed.

In addition, antenna layer 20 may be quadrilateral in shape, and first ground electrode portion 31a may overlap the corners of antenna layer 20 when seen from the direction perpendicular to the other main surface 10b.

According to this configuration, the influence of electromagnetic waves radiated backward from antenna layer 20 can be further suppressed.

### Other Embodiments, Etc.

Although planar antenna devices 1, 1A, 1B, and 1C according to the present disclosure have been described above with reference to Embodiments 1 to 3, the planar antenna device of the present disclosure is not limited to the above embodiments. Other embodiments realized by combining arbitrary components in the above embodiments, variations obtained by applying various modifications to the above embodiments conceived by a person skilled in the art without departing from the scope of the present disclosure, and various devices incorporating the planar antenna device of the present disclosure are also included in the present disclosure.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The planar antenna device of the present disclosure can be widely used, for example, as an antenna for radar or an antenna for sensor devices.

1. A planar antenna device comprising:
a dielectric;
an antenna layer provided on one main surface of the dielectric; and
a ground layer provided on an other main surface of the dielectric to oppose the antenna layer,
wherein the planar antenna device generates an electric field in a first direction along the other main surface by radiating radio waves with linear polarization from the antenna layer,
the ground layer includes a ground electrode portion and a plurality of openings positioned in regions other than the ground electrode portion, the ground electrode portion being grid-like, each of the plurality of openings being quadrilateral in shape,
each of the plurality of openings includes two first opening sides parallel to the first direction and two second opening sides perpendicular to the first direction, and
a length of the first opening sides is longer than a length of the second opening sides.

2. The planar antenna device according to claim 1,
wherein the length of the first opening sides is at most 0.1 times longer than a wavelength of the radio waves.

3. The planar antenna device according to claim 1,
wherein the length of the second opening sides is at most 0.05 times longer than a wavelength of the radio waves.

4. The planar antenna device according to claim 1,
wherein the plurality of openings are provided in a matrix along the other main surface,
the ground electrode portion is positioned at least between adjacent two of the plurality of openings along the other main surface, and
a width of the ground electrode portion positioned between the adjacent two of the plurality of openings is shorter than or equal to the length of the second opening side.

5. A planar antenna device comprising:
a dielectric;
an antenna layer provided on one main surface of the dielectric; and
a ground layer provided on an other main surface of the dielectric to oppose the antenna layer,
wherein the planar antenna device generates an electric field in a first direction along the other main surface by radiating radio waves with linear polarization from the antenna layer,
the ground layer includes a ground electrode portion and a plurality of openings positioned in regions other than the ground electrode portion, the ground electrode portion being grid-like, each of the plurality of openings being quadrilateral in shape,
each of the plurality of openings includes two first opening sides parallel to the first direction and two second opening sides perpendicular to the first direction,
a length of the first opening sides is at most 0.1 times longer than a wavelength of the radio waves, and
a length of the second opening sides is at most 0.1 times longer than the wavelength of the radio waves.

6. The planar antenna device according to claim 5,
wherein the length of the second opening sides is at most 0.05 times longer than the wavelength of the radio waves.

7. The planar antenna device according to claim 5,
wherein the plurality of openings are provided in a matrix along the other main surface,
the ground electrode portion is positioned at least between adjacent two of the plurality of openings along the other main surface, and
a width of the ground electrode portion positioned between the adjacent two of the plurality of openings is shorter than or equal to the length of the second opening side.

8. A planar antenna device comprising:
a dielectric;
an antenna layer provided on one main surface of the dielectric; and
a ground layer provided on an other main surface of the dielectric to oppose the antenna layer,
wherein the ground layer includes a first ground electrode portion, a second ground electrode portion positioned in a region different from the first ground electrode portion, and a plurality of openings positioned in regions other than the first ground electrode portion and the second ground electrode portion, the first ground electrode portion being planar, the second ground electrode portion being grid-like, each of the plurality of openings being quadrilateral in shape, and
at least part of the first ground electrode portion overlaps the antenna layer when seen from a direction perpendicular to the other main surface.

9. The planar antenna device according to claim 8,
wherein the first ground electrode portion is larger than the antenna layer when seen from the direction perpendicular to the other main surface.

10. The planar antenna device according to claim 8,
wherein the antenna layer is quadrilateral in shape, and
the first ground electrode portion overlaps a corner of the antenna layer when seen from a direction perpendicular to the other main surface.
